(19) United States
(12) Patent Application Publication
(10) Pub. No.: US 2006/0137918 A1
(43) Pub. Date: Jun. 29, 2006

(54) Power supply circuit for a motor vehicle electric system

(75) Inventors: Wolfgang Dinser, ALTBACH (DE); Matthias Kronewitter, Esslingen (DE); Anton Heni, Kernen (DE); Irmgard Heni, Kernen (DE)

Correspondence Address: FITCH, EVEN, TABIN & FLANNERY, P. O. BOX 65973, WASHINGTON, DC, 20035, US

(73) Assignee: DAIMLERCHRYSLER AG, STUTTGART (DE)

(21) Appl. No.: 10/544,789

(22) PCT Filed: Dec. 13, 2003
(86) PCT No.: PCT/EP03/14219

§ 371 Date: Sep. 14, 2005

(30) Foreign Application Priority Data
Feb. 7, 2003 (DE) 103 05 058.2

(51) Int. Cl. B60K 1/00

(52) U.S. Cl. 180/65.1

(57) ABSTRACT

The present invention discloses a power supply circuit for a motor vehicle electric system having a starter generator (1), a power electronics system (LE), at least one battery (B), at least one dynamic energy accumulator (3) and a DC/DC converter (2). The power supply circuit has a first connection branch which is provided with the DC/DC converter (2) and is connected to a terminal of the dynamic energy accumulator (3) and a second connection branch which is connected to a terminal of the battery (B). Both connection branches can be disconnected from the starter generator (1) by means of controllable switches (S1, S2). A control device (5) actuates the switches (S1, S2) in the first and second connection branches and the DC/DC converter (2) in response to a charge state of the battery (B) and of the energy accumulator (3) and an operating state of the motor vehicle in such a way that recuperation energy which is present in the energy accumulator (3) is stored, drive support is provided by energy from the energy accumulator (3) as soon as the latter is charged, and until then from the battery (B), and for a rapid start energy is used from the energy accumulator (3) and the battery is charged according to its charge state as required, and after a recuperation the vehicle electric system is fed via the battery (B).

The invention relates to a power supply circuit for a motor vehicle electric system as claimed in the preamble of patent claim 1.

In power supply circuits for motor vehicle electric systems for vehicles having starter/generator systems for stopping/starting and recuperation, the corresponding loads on the vehicle electric system due to starting, stopping or recuperation are covered by means of a capacitor in which excess energy is stored or from which energy is drawn. As a result of the formation of the capacitor the battery can be relieved and its service life thus increased. In particular the consumption potential can be optimized by recuperation by means of the reproducible behavior of a capacitor as against that of a battery. By using a capacitor with a higher voltage level than is permitted in a 12V vehicle electric system, for example 20V, the stored energy can be increased in the case of recuperation and the starting time of the engine in the stopping/starting operating mode can be reduced.

DE 199 17 294 A1 discloses a vehicle electric system for motor vehicles, which comprises at least one battery, a generator and electric consumers. The battery and the generator are connected in parallel with one another. A dynamic energy accumulator is connected in parallel between the battery and the generator and a controllable switch, which can be activated as a function of the charge state of the battery and/or of the operating temperature is arranged between the battery and the dynamic energy accumulator. When a threshold value of the operating temperature is exceeded or if the battery is just below the full charge, the controllable switch is opened in order to prevent the battery being destroyed.

Furthermore DE 198 46 319 C1 discloses a power supply circuit for a motor vehicle electric system having two voltage supply branches at different voltage levels. In this context, the first voltage supply branch is fed by the second voltage supply branch via an electric direct voltage converter and the two voltage supply branch is fed by a generator. At least one voltage supply branch is buffered by an assigned energy accumulator. A multiple converter with three voltage levels is formed, one input/output of which is connected to the second voltage supply branch, the other input/output of which is connected to the first voltage supply branch and the third input/output of which is connected to the energy accumulator which is assigned to the first voltage supply branch. The multiple converter permits the power currents to be divided in a variable manner between various inputs/outputs as required.

In addition, DE 196 28 877 A1 discloses a vehicle electric system for vehicles, in which a battery and a high-performance energy accumulator, for example a super capacitor, are charged alternately by brake energy, inter alia. The stored energy is used, inter alia, to accelerate the vehicle. In addition, the battery can be recharged with excess energy from the high-performance energy accumulator.

Finally, DE 100 63 751 A1 discloses a vehicle electric system which has a starter generator.

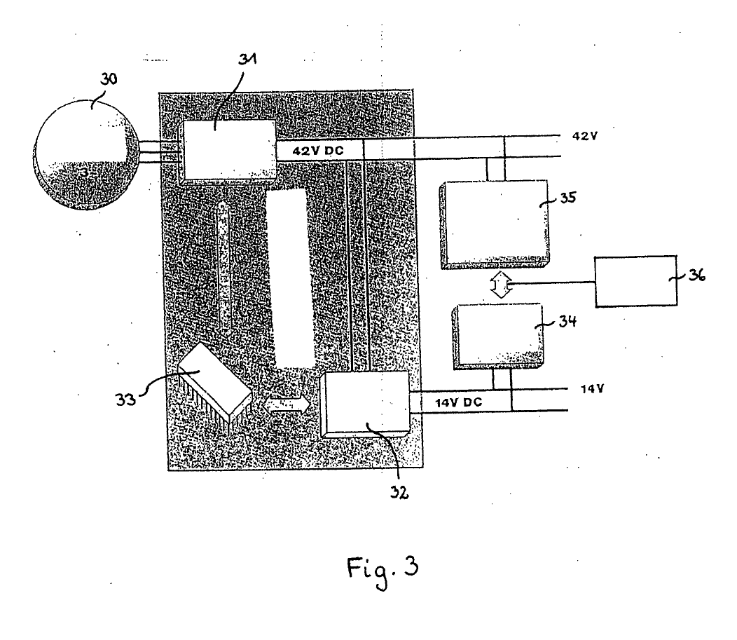

An ISAD (Integrated Starter Alternator Damper) system, i.e. a vehicle electric system for an integrated starter/generator, as is sold, for example, by Continental, is shown in FIG. 3. The ISAD system comprises a two-voltage vehicle electric system for 12V and 42V and has the following design. An ISAD machine 30 is connected via a frequency converter 31 to a 42V vehicle electric system which is used, for example, for an electronic A/C compressor, an electronic steering system, an electronic valve controller, an electronic catalytic converter heater etc. Furthermore, the frequency converter 31 is connected via a DC/DC converter 32 to a 12V vehicle electric system which is used for light, radio, ECU etc. The frequency converter 31, like the DC/DC converter 32, is monitored by a control unit 33. Furthermore, both a 12V battery 34 which is connected to the 12V vehicle electric system and a 42V starter battery 35 are connected to the 42V vehicle electric system. The two batteries 34, 35 are each connected to a battery status monitoring system 36. For example an ultracap is used as energy accumulator with a low internal resistance. The energy accumulator is integrated into the vehicle electric system via a bidirectional DC/DC converter.

However, with such a conventional system or such a power supply circuit for a motor vehicle electric system it is a problem that the DC/DC converter has to be configured for the maximum power of the energy accumulator. This results in a relatively large degree of expenditure and higher costs, in particular since a large battery is also necessary.

For this reason the object of the present invention is to develop a power supply circuit for a motor vehicle electric system in such a way that it is no longer necessary to configure the DC/DC converter for the maximum power of the energy accumulator and the battery can be reduced in size without decreasing the reliability of the vehicle electric system and/or the starting reliability.

This object is achieved according to the invention by means of a power supply circuit for a motor vehicle electric system having the features of patent claim 1. Advantageous developments of the invention are specified in the subclaims.

The direct coupling of the energy accumulator to the starter/generator makes the losses small. In addition, voltage-regulated charging of a discharged energy accumulator via the starter/generator is possible, as a result of which better efficiency can be obtained than with the DC/DC converter. In addition, a DC/DC converter which is configured for the average power of the energy accumulator is now sufficient for integrating the energy accumulator into the vehicle electric system.

The inventive power supply circuit for a motor vehicle electric system will now be explained in more detail below by means of a preferred exemplary embodiment and with reference to the drawing in which:

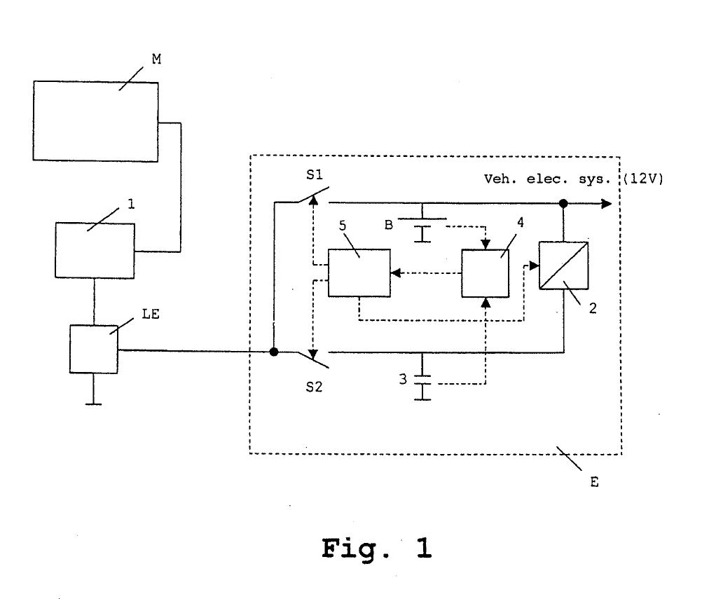

FIG. 1 is a block circuit diagram of an inventive power supply circuit for a motor vehicle electric system,

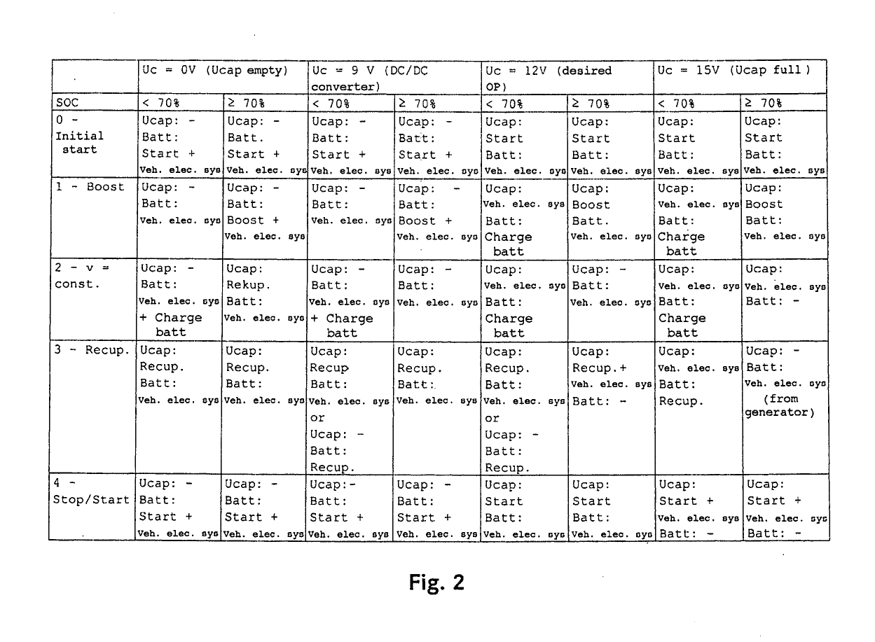

FIG. 2 is an illustration of various operating states and associated charge stages of an energy accumulator and the correspondingly used power sources for the vehicle electric system in the form of a table, and

FIG. 3 shows the design of a conventional ISAD system for a 12V/42V vehicle electric system.

FIG. 1 shows an inventive power supply circuit for a motor vehicle electric system using the example of a motor vehicle with a 12V vehicle electric system. Of course, the power supply circuit according to the invention can also be used in vehicle electric systems with a different voltage level or with multivoltage vehicle electric systems. In the case of multivoltage vehicle electric systems it is then possible to modify one or more of the respective voltage branches according to the invention.

In FIG. 1, M designates an engine and 1 designates a starter generator which may be either a belt-driven starter generator or an integrated starter generator which is connected to the engine M. The starter generator 1 is connected to the power supply circuit EV according to the invention via a power electronics system LE.

This power supply circuit has two different voltage supply branches. The first voltage supply branch has a switch S1 via which the starter generator 1 with the downstream power electronics system LE can be connected directly to a battery B, in the described exemplary embodiment a 12V battery with 70 Ah, and to the vehicle electric system, here a 12V vehicle electric system. The second voltage supply branch has a switch S2 via which the starter generator 1 with a downstream power electronics system LE can be connected directly to an energy accumulator 3, for example an ultracap for 14V/550F and via a DC/DC converter 2 to the vehicle electric system, here the 12V vehicle electric system. Furthermore, the power supply circuit E has a monitoring device 4 which monitors the charge state of the battery B and of the energy accumulator 3. The monitoring result of the monitoring device 4 is fed to a control device 5 which, in response to this monitoring result, i.e. the charge states of the battery B and of the energy accumulator 3 and an operating state of the engine (sensed by a device which is not shown), i.e. one of the states 0 to 4 specified in the following FIG. 2, i.e. initial start, acceleration (boost), constant velocity, braking (recuperation) or starting/stopping, controls switching over of the switches S1 and S2 and the DC/DC converter, in such a way that the smallest possible energy consumption and the maximum possible energy storage is always brought about.

The precise method of functioning of the control device, i.e. the actuation of the switches S1 and S2 as a function of the detected charge state of the battery B and of the energy accumulator 3 as well as of the operating state of the vehicle becomes clearer in conjunction with FIG. 2. Controllable semiconductor switches are preferably used as switches S1 and S2.

In FIG. 2, various operating states of the vehicle with the starter/generator 1 and various charge states of the energy accumulator 3 are shown next to one another in table form and the corresponding power supply states of the energy accumulator 3 and of the battery B are specified. In addition, a charge state SOC of the battery B<70% is differentiated from a charge state SOC of the battery B>70%.

It is necessary to differentiate between five different states, specifically state 0=initial start, state 1=acceleration (boost), state 2=constant velocity (v=constant), state 3=recuperation (braking process) and state 4=stopping/starting. With respect to these, a more detailed explanation is given below of how the energy is drawn from and supplied to the energy accumulator 3 and/or battery B. In the following explanation the state in which the control device 5 controls the switches S1 and S2 is additionally specified.

State 0=initial start:

In the case of an initial start which is shown as state 0 in FIG. 2, as long as the energy accumulator 3 is empty, i.e. Uc=0V or is at the voltage level of the DC/DC converter 2, i.e. for example Uc=9V, the energy accumulator 3 is not discharged and the battery B supplies the energy both for the starting process and for the vehicle electric system. This is independent of the charge state SOC of the battery B. In this case, the switch S1 is closed and the switch S2 is open.
If the energy accumulator 3 has a charge state corresponding to a desired operation point, for example Uc=12V, or is completely charged, for example Uc=15V, the energy which is necessary for starting is drawn from the energy accumulator 3 irrespective of the charge state SOC of the battery B and the vehicle electric system is supplied by the battery B. In this case, the switch S1 is opened and the switch S2 is closed.
   State 1=acceleration:
In the case of an acceleration of the vehicle, in the case of an empty energy accumulator 3, i.e. Uc=0V, or if the energy accumulator 3 is at the voltage level of the DC/DC converter 2, for example Uc=9V, and in the case of a charge state SOC of the battery B<70%, only the vehicle electric system is supplied with energy from the battery B and in such a case the switches S1 and S2 are opened, while in the case of a better charge state SOC of the battery B the battery B also additionally supplies the energy for the acceleration, and in such a case the switch S1 is closed and the switch S2 is opened.
If, on the other hand, the energy accumulator 3 is at the desired operating point, i.e. Uc=12V or the energy accumulator 3 is full, i.e. Uc=15V, in the case of a charge state SOC of the battery B<70% the vehicle electric system is supplied with energy from the energy accumulator 3 and the battery B is charged. In this state, the switch S1 is closed and the switch S2 is opened. On the other hand, in the case of a charge state SOC of the battery B<70% the energy accumulator 3 supplies the energy for the acceleration and the battery B supplies the energy for the vehicle electric system. In such a case, the switch S1 is opened and the switch S2 is closed.
   State 2=constant velocity:
In the case of a constant velocity of the vehicle, when the energy accumulator 3 is empty, i.e. Uc=0V and there is a charge state SOC of the battery B<70%, the vehicle electric system is supplied with energy by the battery B and the battery B is charged. For this purpose, the switch S1 is closed and the switch S2 is opened. If, on the other hand, the charge state SOC of the battery B is <70%, the energy accumulator 3 is charged by means of recuperation via the generator 1 and the vehicle electric system is supplied with energy by the battery B. In such a case the switch S1 is opened and the switch S2 is closed.
In the case of a voltage level of the energy accumulator 3 corresponding to that of the DC/DC converter 2, i.e. for example 9V, in the case of a charge state SOC of the battery B<70%, the vehicle electric system is supplied with energy by the battery B and the battery B is charged. In such a case the switch S1 is closed and the switch S2 is opened. If, on the other hand, the charge stage SOC of the battery B is >70%, only the vehicle electric system is supplied with energy by the battery B. In such a case the switches S1 and S2 are opened.
In the case of a voltage level of the energy accumulator 3 corresponding to the desired operating point, i.e. for example 12V, in the case of a charge state SOC of the battery B<70%, the vehicle electric system is supplied with energy by the energy accumulator 3 and the battery B is charged.
In such a case the switch S1 is closed and the switch S2 is opened. If, on the other hand, the charge state SOC of the battery B is >70%, the vehicle electric system is supplied with energy by the battery B. In such a case the switches S1 and S2 are opened.
If the energy accumulator 3 is full, i.e. for example Uc=15V, in the case of a charge state SOC of the battery B<70%, the vehicle electric system is supplied with energy from the energy accumulator 3 and the battery B is charged. In this state, the switch S1 is closed and the switch S2 is opened. If, on the other hand, the charge state SOC of the battery B is >70%, the vehicle electric system is supplied with energy from the energy accumulator 3. In such a case the switches S1 and S2 are opened.
   State 3=recuperation (braking process):
In the case of a braking process, when the energy accumulator 3 is empty the energy accumulator 3 is charged by recuperation via the generator 1 and the vehicle electric system is supplied with energy by the battery B, irrespective of the charge state SOC of the battery B. In such a case the switch S1 is opened and the switch S2 is closed.
If the energy accumulator 3 is at the voltage level of the DC/DC converter 2, i.e. for example Uc=9V, the energy accumulator 3 is charged by recuperation via the generator 1 and the vehicle electric system supplied with energy by the battery B, irrespective of the charge state SOC of the battery B. Alternatively, it is possible, in the case of a charge state SOC of the battery B<70%, to charge the battery B by means of recuperation via the generator 1. In the first case, the switch S1 is opened and the switch S2 is closed here, while in the case of the alternative precisely the converse is true.
If the energy accumulator 3 is at the desired operating point, i.e. for example Uc=12V, in the case of a charge state SOC of the battery B<70%, the energy accumulator 3 is charged by means of recuperation via the generator 1 and the battery B supplies the vehicle electric system. The switch S1 is then opened and the switch S2 closed. Alternatively it is also possible for just the battery B to be charged by means of recuperation via the generator 1. In such a case the switch S1 is closed and the switch S2 opened. If the charge state SOC of the battery B is >70%, the energy accumulator 3 is charged by means of recuperation via the generator 1 and supplies the vehicle electric system. For this purpose, the switch S1 is opened and the switch S2 closed.
Finally, if the energy accumulator is full, i.e. for example Uc=15V, in the case of a charge state SOC of the battery B<70%, the vehicle electric system is supplied with energy from the energy accumulator 3 and the battery B is charged by means of recuperation via the generator 1. In such a case the switch S1 is closed and the switch S2 is opened. If, on the other hand, the charge state SOC of the battery B is >70%, the vehicle electric system is supplied with energy from the battery B. For this purpose the switches S1 and S2 are opened.
   State 4=stopping/starting:
If the energy accumulator 4 is empty or has a voltage level corresponding to the DC/DC converter 2, for example Uc=9V when the vehicle is starting or stopping, the energy which is necessary for starting and the energy for supplying the vehicle electric system is supplied by the battery B irrespective of the charge state SOC of the battery B. In such a case the switch S1 is closed and the switch S2 is opened.
If the energy accumulator is at the desired operating point, i.e. for example Uc=12V, the energy which is necessary for starting is drawn from the energy accumulator 3 irrespective of the charge state of the battery B and the vehicle electric system is supplied with energy by the battery B. In this state, the switch S1 is closed and the switch S2 is opened.
Finally, if the energy accumulator 3 is full, i.e., for example, Uc=15V, the energy for starting and for supplying the vehicle electric system is drawn from the energy accumulator 3. For this purpose, the switch S2 is closed and the switch S1 is opened.

The voltage of the energy accumulator 3 is dependent on its capacity and the power electronics system (for example 30V), the integrated starter/generator 1 and the DC/DC converter 2. In the case of voltages of more than 15V, a further recuperation mode is possible for all states. To be precise, combined recuperation may take place, i.e. if the generator voltage U_{Gen} is >15V, the recuperation occurs into the energy accumulator 3, and otherwise it occurs into the battery B.

As a result, with the vehicle electric system architecture according to the invention energy is supplied from the battery B only for initial starting, while for later starting or stopping operations energy is supplied by means of the energy accumulator 3, which is, for example, an ultracap.

Recuperation occurs primarily by means of the energy accumulator 3. As a result, the battery B can be charged to a level of 95-100% and a constant recuperation energy which is independent of the state of the battery can be stored.

The vehicle electric system is supplied via the DC/DC converter 2 during the recuperation. After the recuperation, the vehicle electric system is supplied via the battery B if drive support is not possible or not necessary.

If there is excess recuperation energy, energy can be fed back into the battery B and 85% is then set as the charge state threshold instead of 70%.

With the vehicle electric system architecture according to the invention it is possible for drive support to be provided by the integrated starter/generator with the energy from the energy accumulator 3.

Until the energy accumulator 3 is charged after an initial start, drive support is provided from the battery B.

While recuperation occurs into the energy accumulator 3, the vehicle electric system is supplied via the DC/DC converter 2 and/or the battery B. In this way it is then possible to configure the DC/DC converter 2 only for the average power of the energy accumulator 3.

A starting process, i.e. for example a rapid starting process with U>>12V basically takes place via the energy accumulator 3 without DC/DC coupling.

The vehicle electric system according to the invention allows the battery size to be reduced. This has advantages in terms of weight, packaging and costs.

In addition, the service life of the battery B is increased since its loading is reduced.

Finally, the battery B can be charged as required using the DC/DC converter 2, which further increases the vehicle electric system reliability and starting reliability.

Finally, the starting reliability is also increased further with a partially discharged battery B.

To summarize, the present invention discloses a power supply circuit for a motor vehicle electric system having a starter generator, a power electronics system, at least one battery, at least one dynamic energy accumulator and a DC/DC converter. The power supply circuit has a first connection branch which is provided with the DC/DC converter and is connected to a terminal of the dynamic energy accumulator, and a second connection branch which is connected to a terminal of the battery. Both connection branches can be disconnected from the starter generator by means of controllable switches. A control device actuates the switches in the first and second connection branches and the DC/DC converter in response to a charge state of the battery and of the energy accumulator and an operating state of the motor vehicle in such a way that recuperation energy which is present in the energy accumulator is stored, drive support is provided by energy from the energy accumulator as soon as the latter is charged, and until then from the battery, and for a rapid start energy is used from the energy accumulator and the battery is charged according to its charge state as required and after a recuperation the vehicle electric system is fed via the battery.

1. A power supply circuit for a motor vehicle electric system having:
a starter generator (1),
a power electronics system (LE),
at least one battery (B),
at least one dynamic energy accumulator (3) and a DC/DC converter (2), wherein the starter generator (1) can be connected to the vehicle electric system via a first connection branch in which the DC/DC converter (2) is arranged, characterized in that the starter generator (1) can be connected to the vehicle electric system via a second connection branch,
wherein both the first and the second connection branches each have, at their side connected to the starter generator (1), a switch (S1, S2) by means of which the connection branch can be disconnected,
the battery (B) is connected on the vehicle electric system side between the second connection branch and ground,
the energy accumulator (3) is connected between the switch (S2) in the first connection branch and the DC/DC converter (2) between ground and the first connection branch, and
a control device (5) is formed which actuates switches (S1, S2) in the first and the second connection branches and the DC/DC converter (2) in response to a charge state of the battery (B) and of the energy accumulator (3) and an operating state of the motor vehicle in such a way that
recuperation energy which is present in the energy accumulator (3) is stored and recuperation energy which is present is optionally used to charge the battery (B) if the energy accumulator (3) is fully charged,
drive support is provided by energy from the energy accumulator (3) as soon as the energy accumulator (3) is charged after an initial start, and drive support is provided from the battery (B) up to this time,
for a rapid start energy is used from the energy accumulator (3),
the battery is charged according to its charge state as required, and
after a recuperation the vehicle electric system is fed via the battery (B).

2. The power supply circuit for a motor vehicle electric system as claimed in claim 1, characterized in that a monitoring device (4) is also formed which monitors the charge state of the battery (B) and of the energy accumulator (3) and transfers the monitoring result to the control device (5).

3. The power supply circuit for a motor vehicle electric system as claimed in claim 1, characterized in that the switches (S1, S2) are embodied as controllable semiconductor switches.

4. The power supply circuit for a motor vehicle as claimed in claim 1, characterized in that the dynamic energy accumulator (4) is embodied as a capacitor.

5. The power supply circuit for a motor vehicle as claimed in claim 4, characterized in that the capacitor is embodied as a supercap or ultracap.

6. The power supply circuit for a motor vehicle electric system as claimed in claim 2, characterized in that the switches (S1, S2) are controllable semiconductor switches.
